(19) United States
(12) Patent Application Publication
(10) Pub. No.: US 2014/0257914 A1
(43) Pub. Date: Sep. 11, 2014

(54) PROVIDING INTERACTION EFFICIENCY INFORMATION TO A CUSTOMER

(71) Applicant: BANK OF AMERICA CORPORATION, Charlotte, NC (US)

(72) Inventors: Matthew A. Calman, Charlotte, NC (US); David M. Grigg, Rock Hill, SC (US); Carrie Anne Hanson, Charlotte, NC (US)

(73) Assignee: Bank of America Corporation, Charlotte, NC (US)

(21) Appl. No.: 13/791,441

(22) Filed: Mar. 8, 2013

(51) Int. Cl. G06Q 10/06

(52) U.S. Cl. CPC G06Q 10/0633
USPC 705/7.27

(57) ABSTRACT

Embodiments of the invention are directed to systems, methods and computer program products for providing interaction efficiency information to a customer. Embodiments determine that the customer is traveling to or is currently located in proximity to a financial institution physical location; determine interaction efficiency information associated with the financial institution physical location; and provide the determined interaction efficiency information to the customer. The interaction efficiency information may include information related to one or more wait times at the financial institution physical location, where the one or more wait times include a wait time for a drive through station outside the financial institution physical location and a wait time for a teller inside the financial institution physical location. In some embodiments, the interaction efficiency information includes one or more visual representations of one or more wait lines associated with one or more stations of the financial institution physical location.

### BACKGROUND

Sometimes, a financial institution customer is in route to a financial institution physical location or is currently at a location and has business to conduct with the financial institution.

### BRIEF SUMMARY

Embodiments of the invention are directed to systems, methods and computer program products for providing interaction efficiency information to a customer.

According to embodiments of the invention, a system includes a memory device storing computer executable code and a processing device to execute the computer executable code to cause the processing device to determine that the customer is traveling to or is currently located in proximity to a financial institution physical location; determine interaction efficiency information associated with the financial institution physical location; and provide the determined interaction efficiency information to the customer.

In some embodiments, the interaction efficiency information comprises information related to one or more wait times at the financial institution physical location. In some such embodiments, the one or more wait times comprise a wait time for a drive through station outside the financial institution physical location and a wait time for a teller inside the financial institution physical location.

In some embodiments, the interaction efficiency information comprises one or more visual representations of one or more wait lines associated with one or more stations of the financial institution physical location.

In some embodiments, the interaction efficiency information comprises one or more estimated wait times associated with one or more stations of the financial institution physical location. In some such embodiments, the one or more estimated wait times are calculated based on a number of people in a wait line for a station and historical data associated historical average wait time data for a person to matriculate through a hypothetical station representing the station.

In some embodiments, the one or more estimated wait times are calculated based on historical wait time information associated with a specific teller of the financial institution physical location or a specific station of the financial institution physical location.

According to embodiments of the invention, a computer program product is configured for providing interaction efficiency information to a customer. The computer program product has a non-transitory computer readable medium having computer executable code stored thereon to cause a processing device to determine that the customer is traveling to or is currently located in proximity to a financial institution physical location; determine interaction efficiency information associated with the financial institution physical location; and provide the determined interaction efficiency information to the customer.

In some embodiments, the interaction efficiency information comprises information related to one or more wait times at the financial institution physical location. In some such embodiments, the one or more wait times comprise a wait time for a drive through station outside the financial institution physical location and a wait time for a teller inside the financial institution physical location.

In some embodiments, the interaction efficiency information comprises one or more visual representations of one or more wait lines associated with one or more stations of the financial institution physical location.

In some embodiments, the interaction efficiency information comprises one or more estimated wait times associated with one or more stations of the financial institution physical location. In some such embodiments, the one or more estimated wait times are calculated based on a number of people in a wait line for a station and historical data associated historical average wait time data for a person to matriculate through a hypothetical station representing the station.

In some embodiments, the one or more estimated wait times are calculated based on historical wait time information associated with a specific teller of the financial institution physical location or a specific station of the financial institution physical location.

According to embodiments of the invention, a computer-implemented method for providing interaction efficiency information to a customer includes providing a memory device storing computer executable code and a processing device to execute the computer executable code to cause the processing device to determine that the customer is traveling to or is currently located in proximity to a financial institution physical location; determine interaction efficiency information associated with the financial institution physical location; and provide the determined interaction efficiency information to the customer.

In some embodiments, the interaction efficiency information comprises information related to one or more wait times at the financial institution physical location. In some such embodiments, the one or more wait times comprise a wait time for a drive through station outside the financial institution physical location and a wait time for a teller inside the financial institution physical location. In some such embodiments, the interaction efficiency information comprises one or more visual representations of one or more wait lines associated with one or more stations of the financial institution physical location.

In some embodiments, the interaction efficiency information comprises one or more estimated wait times associated with one or more stations of the financial institution physical location. In some such embodiments, the one or more estimated wait times are calculated based on a number of people in a wait line for a station and historical data associated historical average wait time data for a person to matriculate through a hypothetical station representing the station.

In some embodiments, the one or more estimated wait times are calculated based on historical wait time information associated with a specific teller of the financial institution physical location or a specific station of the financial institution physical location.

### BRIEF DESCRIPTION OF THE DRAWINGS

Having thus described embodiments of the invention in general terms, reference will now be made to the accompanying drawings, where:

FIG. 1 is a block diagram of environment 100, in which systems operate according to embodiments of the invention;

FIG. 2 is a flowchart illustrating a method 200 for providing interaction efficiency information to a customer according to embodiments of the invention;

FIG. 3 is a flowchart illustrating a method 300 for determining an estimated wait time for an interaction channel or station of the FIPL according to embodiments of the invention;

FIG. 4 is a flowchart illustrating a method 400 for presenting a representation of the wait time for a station to the customer according to embodiments of the invention;

FIG. 5 is a flowchart illustrating a method 500 for providing an efficient interaction path for a customer according to embodiments of the invention;

FIG. 6 is a flowchart illustrating a method 600 for determining the expected business of the customer according to embodiments of the invention;

FIG. 7 is a flowchart illustrating a method 700 for determining an interaction path not associated with the financial institution physical location;

FIG. 8 is a flowchart illustrating a method 800 for balancing a load of financial transaction channels according to embodiments of the invention;

FIG. 9 is a flowchart illustrating a method 900 for determining a recommended interaction path according to embodiments of the invention;

FIG. 10 is a flowchart illustrating a method 1000 for determining a recommended interaction path according to embodiments of the invention;

FIG. 11 is a flowchart illustrating a method 1100 for providing special resource availability information to a customer;

FIG. 12 is a flowchart illustrating a method 1200 for determining presence of a financial specialist at the FIPL according to embodiments of the invention;

FIG. 13 is a flowchart illustrating a method 1300 for determining whether a special resource is present or absent from the FIPL according to embodiments of the invention; and

FIG. 14 is a flowchart illustrating a method 1400 for providing a recommended interaction path to a customer according to embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for providing interaction efficiency information to a customer. Embodiments determine that the customer is traveling to or is currently located in proximity to a financial institution physical location; determine interaction efficiency information associated with the financial institution physical location; and provide the determined interaction efficiency information to the customer. The interaction efficiency information may include information related to one or more wait times at the financial institution physical location, where the one or more wait times include a wait time for a drive through station outside the financial institution physical location and a wait time for a teller inside the financial institution physical location. In some embodiments, the interaction efficiency information includes one or more visual representations of one or more wait lines associated with one or more stations of the financial institution physical location. The interaction efficiency information may include one or more estimated wait times associated with one or more stations of the financial institution physical location. In some embodiments, the one or more estimated wait times are calculated based on a number of people in a wait line for a station and historical data associated historical average wait time data for a person to matriculate through a hypothetical station representing the station. In some embodiments, the one or more estimated wait times are calculated based on historical wait time information associated with a specific teller of the financial institution physical location or a specific station of the financial institution physical location.

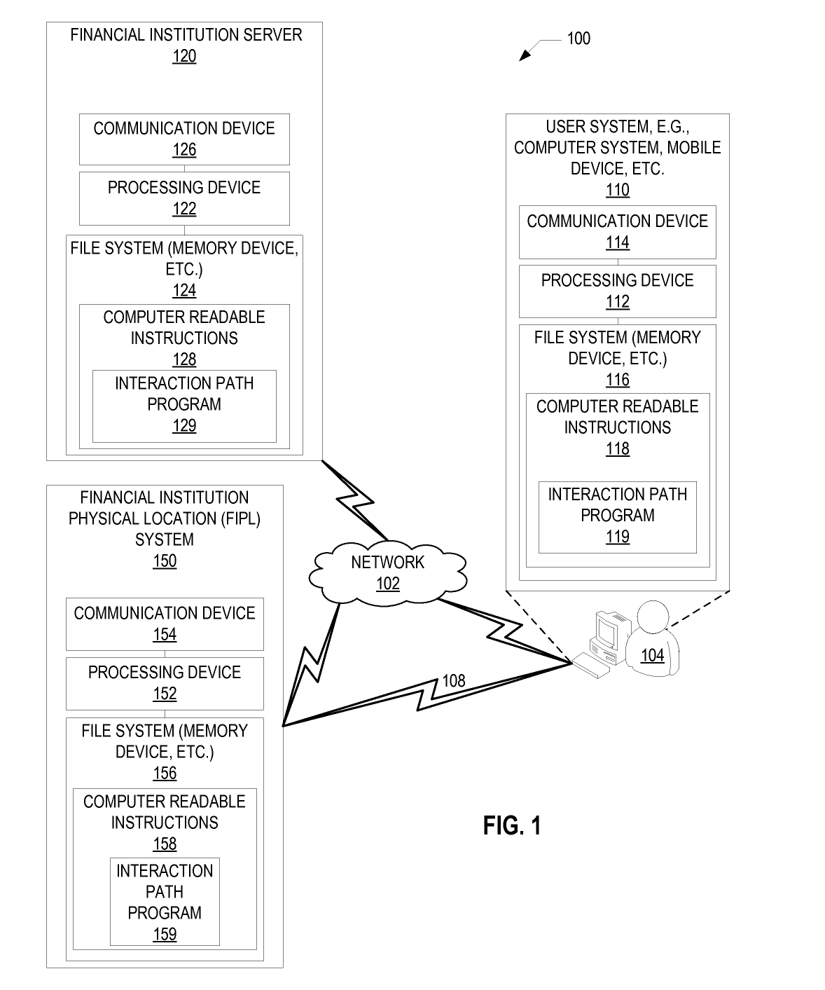

Referring now to FIG. 1, a block diagram of environment 100, in which systems operate according to embodiments of the present invention is shown. FIG. 1 illustrates an environment 100 in which the financial institution (FI) server 120, the user system 110 and the financial institution physical location (FIPL) system 150 interact over a network 102. Each of the systems 120 and 150 communicate over the network 102 with the user system 110. In some embodiments, one or more of the systems 110, 120, and/or 150 communicate directly with one another.

In the various embodiments, the user system 110 is a computer system, mobile device or other computing device used by a client 104 or other user to interact with an organization's servers and/or online content and the like, such as by communicating with the FI server 120 and/or the FIPL system 150. The user system 110 includes, in the embodiment shown, a processing device 112 communicatively coupled with a communication device 114 and a file system 116. The processing device, in some embodiments, is configured for controlling operation of the communication device 114 in order to communicate across the network 102, such as, for example, with the financial institution server 120 and/or the FIPL system 150. The file system 116 is or includes a memory device or other memory configured for storing computer readable instructions 118 such as an operating system, applications, such as a browser and others, other computer program code and the like. In some embodiments, the computer readable instructions include an interaction path program 119 or application configured for instructing the processing device 112 to provide interaction efficiency information to a customer, determine an efficient interaction path for a customer, balance a load of financial transaction channels, provide special resource availability information to a customer and/or perform one or more of the methods and/or steps discussed herein. The interaction path program 119, in some embodiments, is configured for instructing the processing device 112 to communicate with the FI server, 120 and/or the FIPL system 150 either directly or over one or more external networks. The processing device 112, of course, is configured for accessing and/or retrieving some or all the computer readable instructions 118 and executing some or all of them.

In one embodiment, for example, the network 102 is an intranet or other local area network (LAN) and the user system 110, the third party system 120, and the merchant system 150 are all part configured for communicating with one another across the intranet. In such an embodiment, the user system 110, when directed by the user 104 to access a particular intranet webpage, uses a browser program to navigate to the intranet webpage. The browser then requests online interaction, such as webpage content, from the FI server 120.

The FI server 120, in some embodiments, is a server such as an organization server. The organization may be a financial institution in some embodiments. In other embodiments, the FI server 120 represents another user's mobile device or other system. In some such cases, the FI server 120 is considered part of one or more backend systems of a bank. The FI server 120 includes, in some embodiments, a processing device 122 communicatively coupled with a communication device 126 and a file system 124, such as a memory device or memory. The processing device 122 is configured for controlling operation of the communication device 126 for communicating over the network 102 such as with the user system 110 and/or the FIPL system 150. The file system 124 is configured for storing computer readable instructions 128, such as, for example, the interaction path program 129, an operating system, other applications, other computer executable program code and the like. The interaction path program 129 includes program code and/or instructions for performing one or more of the methods and/or method steps discussed herein. The processing device 122, of course, is configured to access and/or retrieve some or all the computer readable instructions 128 and execute some or all of them.

The FIPL system 150 is, in some embodiments, a server such as an organization server, a computer system, another computing device or the like. In some FIPL system 150, in some embodiments, includes a processing device 152 communicatively coupled with a communication device 154 and a file system 156. The processing device 152 is typically configured to control the communication device for communicating across the network 102 with one or more of the other systems, such as the financial institution server 120 and/or the user system 110. The file system 156 is configured for storing computer readable instructions such as an interaction path program 159, an operating system, other computer executable program code, applications and the like. The processing device 152 is configured for accessing and/or retrieving some or all the computer readable instructions 158 from the file system 156 and executing some or all of them. In some embodiments, for example, the interaction path program 159 includes program code configured to instruct the processing device 152 to communicate with the user device 110 either directly or over one or more external networks.

Further, the embodiments described herein may refer to use of a transaction, transaction event, interaction or interaction event. Unless specifically limited by the context, a “transaction” or “interaction” refers to any communication between the user and a merchant, financial institution, insurance company, or other entity, and the terms “transaction” and “interaction” are used interchangeably herein. A “transaction” or “interaction” may also include a bill, statement, purchase at a POT, online purchase, purchase at a merchant, and/or the like. For example, in some embodiments, a transaction may include one or more of the following: purchasing, renting, leasing, bartering, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like. For example, a transaction may occur when a user purchases a product at a merchant. In yet other embodiments, for example, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-transaction terminal.

In still further embodiments, a transaction may refer to an event and/or action or group of actions facilitated or performed by a user's device, such as a user's mobile system, a merchant system, and/or a combination thereof. A device capable of facilitating or performing a transaction may be referred to herein as a “POT system” or “POT device.” A “point-of-transaction” or “POT” could refer to any location, virtual location or otherwise proximate occurrence of a transaction. A POT system may refer to any device used to perform a transaction, either from the user's perspective, the merchant's perspective or both. In some embodiments, the POT system refers only to a user's system, in other embodiments it refers only to a merchant system, and in yet other embodiments, it refers to both a user device and a merchant device interacting to perform a transaction. For example, in one embodiment, the POT system refers to the user's mobile device configured to communicate with a merchant's system, whereas in other embodiments, the POT system refers to a merchant's system configured to communicate with a user's mobile device, and in yet other embodiments, the POT system refers to both the user's mobile device and the merchant's system configured to communicate with each other to carry out a transaction.

In some embodiments, a POT system is or includes an interactive computer terminal that is configured to initiate, perform, complete, and/or facilitate one or more transactions. A POT system could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a POT system is operated in a public place (e.g., on a street corner, at the doorstep of a private residence, in an open market, at a public rest stop, or the like). In other embodiments, the POT system, is additionally or alternatively operated in a place of business (e.g., in a retail store, post office, banking center, grocery store, factory floor, or the like). In accordance with some embodiments, the POT system is not owned by the user of the POT system. Rather, in some embodiments, the POT system is owned by a mobile business operator or a POT operator (e.g., merchant, vendor, salesperson, or the like). In yet other embodiments, the POT system is owned by the financial institution offering the POT system providing functionality in accordance with embodiments of the invention described herein.

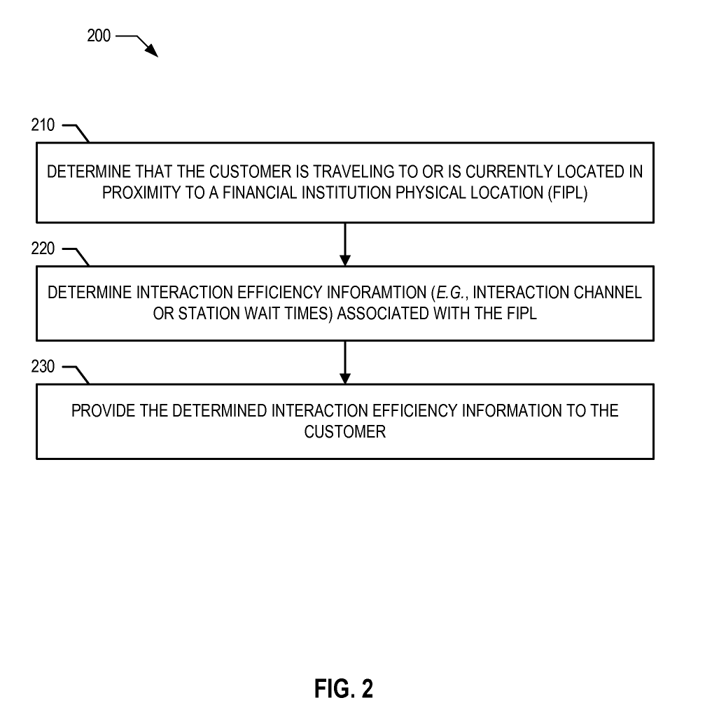

Referring now to FIG. 2, a flowchart illustrates a method 200 for providing interaction efficiency information to a customer according to embodiments of the invention. The first step, represented by block 210, is to determine that the customer is travelling to or is currently located in proximity to a financial institution physical location (FIPL).

The location of the user may be determined based on the location of the user's mobile device. Embodiments of the invention may collect positioning data of the customer, which may include global positioning data. Global positioning data may include any information collected from methods, systems, apparatus, computer programs etc. involving locating a user's position relative to satellites, fixed locations, beacons, transmitters or the like. In some instances, global positioning data may be collected from a GPS device, such as a navigation system. Such a navigation system may be, but is not limited to, hardware and/or software that is part of a mobile phone, smartphone, PDA, automobile, watch etc. or a commercially available personal navigation system. The amount, nature and type of the global positioning data that is collected may depend on the merchant's relationship with the customer and the amount of information that the customer has authorized the merchant or third-party provider to collect. For instances in some embodiments the global positioning data will be snapshots of the user's location at different times. For example, a snapshot of the user's location may be collected each time the GPS software, navigation system or application is activated. The global positioning data may also include the destination entered by the user, recent searches for locations, attractions, addresses etc. In other instances, the global positioning data may be the complete route being provided to the GPS system's user, including destination, route, alternate routes, anticipated time of arrival etc. In some such embodiments, the global positioning data may include an indication if the customer selects a detour from a previously selected route, or instructs the navigation system to reach the desired location taking specific roads or avoiding certain roads. In instances where the user's complete route is provided, additional positioning data may not be necessary to project the route of the customer or can be used to confirm the customer is traveling on along the suggested route.

Positioning data of the customer may include mobile device data. Mobile device data may include information regarding the location of the customer's mobile device. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. For instance, the location of the mobile phone may be dynamically determined from the cell phone signal and cell towers being accessed by the mobile phone. In other instances, a mobile device may include software or hardware to locate the position of the mobile phone from GPS signals, wireless network locations, and the like. Mobile device data may further include information from an accelerometer that is a part of the mobile device and provides information regarding whether the mobile device is moving, and if so, in what direction. In some embodiments, mobile device data may be the time and location of calls placed using the telephone functionality of a mobile device. In yet other embodiments, the mobile device data may be data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (from a compass in the mobile device). Such information may be sufficient to locate the user's position and potentially the direction the user is facing and/or traveling.

The positioning data of the customer may also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks as well as any one or more existing web logs or “blogs,” forums and other social spaces. Social network data may indicate the customer's recent, present or future location through expressed data. For instance, a user may upload a blog post, comment on a connection's page, send a friend an electronic message etc. that she is traveling to a specific location or that she is currently in a specific city, or on a specific road etc. Moreover, many already-existing social networks provide users with the ability to “check-in”, “flag” or otherwise indicate the user's current location. Accordingly, customer positioning data collected from social networking data may consist of such indications. Furthermore, many social networks allow users to rate, like, comment etc. on restaurants, attractions, locations and the like. Accordingly, a customer may indicate that she ate at a certain restaurant or business at a given time and thereby provide information about her location at that time. Furthermore, a customer may upload photographs to a social networking site and thereby provide information about the customer's location. In some instances the customer's location may be determined from the picture, (for example a picture of a state line sign, a highway sign, a mile marker etc.) or a caption associated with the picture may indicate the customer's location and/or the time the photo was taken.

The positioning data of the customer may also be collected from Internet data. Internet data, may include any information relating to the searches conducted by the customer, website's visited by the customer and the like that suggests the customer's present or future location(s). For instance, in preparing for a vacation a customer may conduct searches for hotels, restaurants or activities in the area where the customer will be staying. Similarly, a customer may review weather forecasts for locations other than her place of residence indicating that she may soon be traveling to that location. A customer may also search for construction or traffic reports indicating future travel along certain roads. Moreover, changes in search patterns may suggest a customer's future location. For instance if a customer usually uses a web browser application just to read online news articles or to check sports scores but suddenly begins to search for camping gear, hiking manuals and boots it may be indicative that the customer is anticipating taking a hiking trip and will be traveling away from her home area. It will be understood that such Internet data may relate to searches or websites visited by the customer before she began traveling, however, inasmuch as many mobile devices also include mobile Internet connectivity, it will also be understood that such information may be dynamically collected as the customer travels.

Once the positioning data of the customer is collected from one or more of the global positioning data, mobile device data, social network data and Internet data, the positioning data is analyzed to project the customer's likely route of travel. It will be understood that the positioning data may be data that is available directly to the merchant or data that is collected by other merchants or a third-party service provider and then provided to the merchant. For example, in use, a customer in City One may engage in a transaction consisting of using a credit card to pay a cab fare. The customer's GPS device on her mobile phone, or a phone call placed around the same time, may indicate that she is still in City One but a review of her social networking data indicates she has checked-in on her social network page at City Two Airport. Internet data from the customer's mobile phone indicates that she has recently checked the weather a number of times in City Three. Based on this information, the financial institution may conclude that the customer is likely traveling by plane from City One to City Two.

In some instances in projecting the customer's likely route of travel, the projection will be based on the information currently being collected, e.g. the user's current GPS location, the most recent social network and Internet search data etc. In other instances, the current data will be combined with historical positioning data to project the customer's likely route of travel. For instance, if historical positioning data indicates that when the user leaves her home traveling south bound and then turns onto a specific highway, ninety percent of the time she is traveling to the beach, this information might be used in the future to project the customer's likely route of travel when she begins to follow a similar route. Similarly, the positioning data being currently collected about the customer may be combined with information regarding the travel patterns of other users in similar situations to project the customer's likely route of travel.

The next step, represented by block 220, is to determine interaction efficiency information associated with the FIPL. For example, the interaction efficiency information may be related to a wait time associated with an interaction channel of the FIPL or station of the FIPL. An interaction channel or station may be or include a teller, a drive-through, an ATM or the like. In some embodiments, the interaction efficiency information includes information related to the type of business carried on by each of the channels available at a location, about other channels that are available, regarding the wait times of the various channel and/or other information about the channels available at the location. In some embodiments, the interaction efficiency information includes information about channels external to the FIPL. The next step, represented by block 230, is to provide the determined interaction efficiency information to the customer. This may be done over the application running on the user's mobile device, over a public address system, using email or SMS messaging or the like.

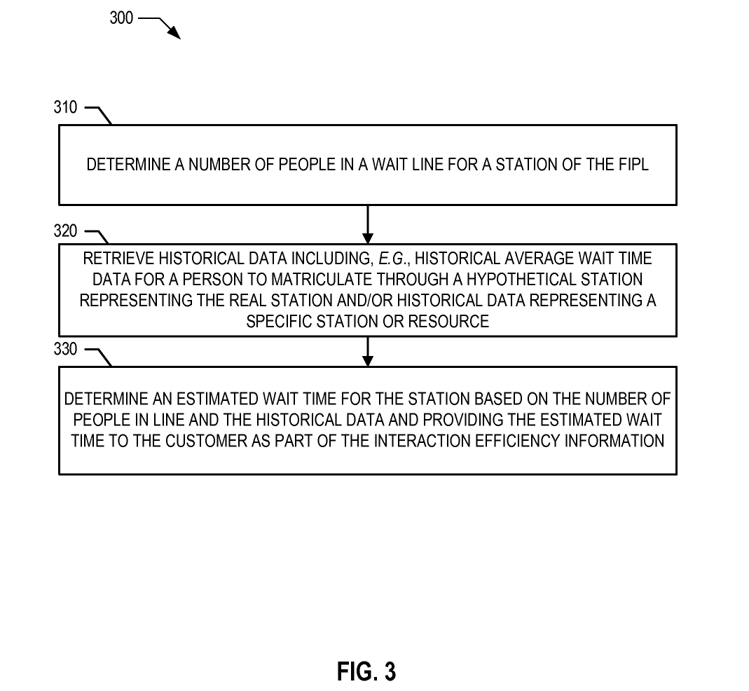

Referring now to FIG. 3, a flowchart illustrates a method 300 for determining an estimated wait time for an interaction channel or station of the FIPL according to embodiments of the invention. The first step, represented by block 310, is to determine a number of people in a wait line for a station of the FIPL. This may be done by using video capture and analysis techniques. For example, a camera may capture a visual of the line associated with a station and the FIPL system 150 may analyze the visual, determine the number of people in line and calculate an estimated wait time for the station.

The next step, represented by block 320, is to retrieve historical data. The historical data may include, for example, an historical average wait time for a person to matriculate through a hypothetical station of the FIPL. This hypothetical station may represent a real station of the FIPL. In some embodiments, the historical data is subjective, that is, it represents a specific station and/or resource such as a specific teller.

The next step, represented by block 330, is to determine an estimated wait time for the station based on the number of people in line and the historical data. For example, if the FIPL system 150 determines there are 10 people in line for a teller, the system may determine an estimated wait time based on historical data indicating the average time a representative teller takes to service a customer. The invention may also provide the estimated wait time to the customer as part of the interaction efficiency information.

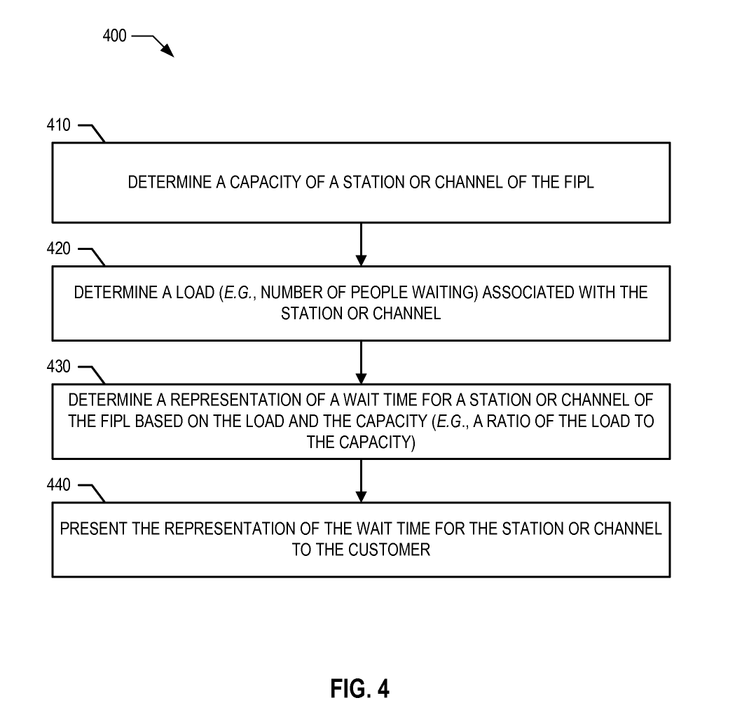

Referring now to FIG. 4, a flowchart illustrates a method 400 for presenting a representation of the wait time for a station to the customer according to embodiments of the invention. The first step, represented by block 410, is to determine a capacity of a station or channel of the FIPL. The full capacity associated with a station may be determined and stored, such as in a database and retrieved for use in method 400 or it may be calculated based on current available resources or otherwise. The next step, represented by block 420, is to determine a load associated with the station or channel. The load may be, for example, the number of people waiting for service from the channel or station and may be related or take into consideration the channel or station's full capacity. The load may be a ratio of the remaining capacity of a station versus the full capacity of the station or otherwise.

The next step, represented by block 430, is to determine a representation of a wait time for a station or channel or the FIPL based on the load and the capacity. For example, the representation may be based on a ratio of the load to the capacity of the channel or station. A representation may include a graphical representation of a nondescript person indicating the number of people in line for a station. It may also be a progress bar or countdown clock or the like. The next step, represented by block 440, is to present the representation of the wait time for the station or channel to the customer.

In various embodiments, the estimated wait time may be calculated based on the individual teller or station's characteristics. This may include the specific teller's experience level or other information about the teller. This may also include other non-normal characteristics of the teller and/or station that would affect the average wait time. The average wait time for each person may then be determined.

In some situations, the wait time may be different for the present versus the customer's arrival time. In some embodiments, the invention provides information regarding the efficiency of the interaction paths for those outside the FIPL. In some cases, the invention may provide the customer directions to another FIPL.

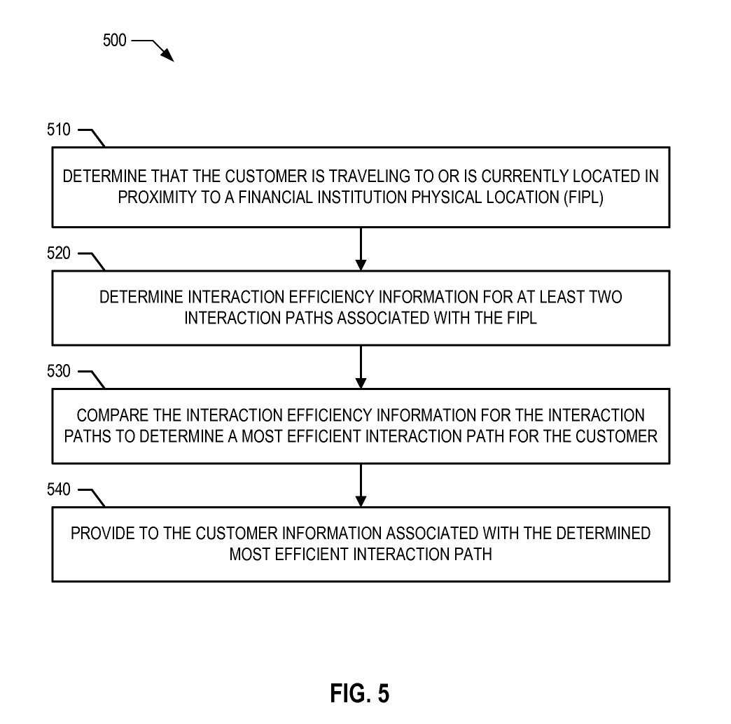

Referring now to FIG. 5, a flowchart illustrates a method 500 for providing an efficient interaction path for a customer according to embodiments of the invention. The first step, represented by block 510, is to determine that the customer is travelling to or is currently located in proximity to a FIPL as discussed in detail above. The next step, represented by block 520, is to determine interaction efficiency information for at least two interaction paths associated with the FIPL, also similar to the discussion above. The next step, represented by block 530, is to compare the interaction efficiency information for the interaction paths to determine a most efficient interaction path for the customer. This may be done by comparing a load of the interaction paths, a wait time for the interaction paths or some other quantifiable characteristic indicating the efficiency of the interaction paths. The next step, represented by block 540, is to provide to the customer information associated with the determined most efficient interaction path.

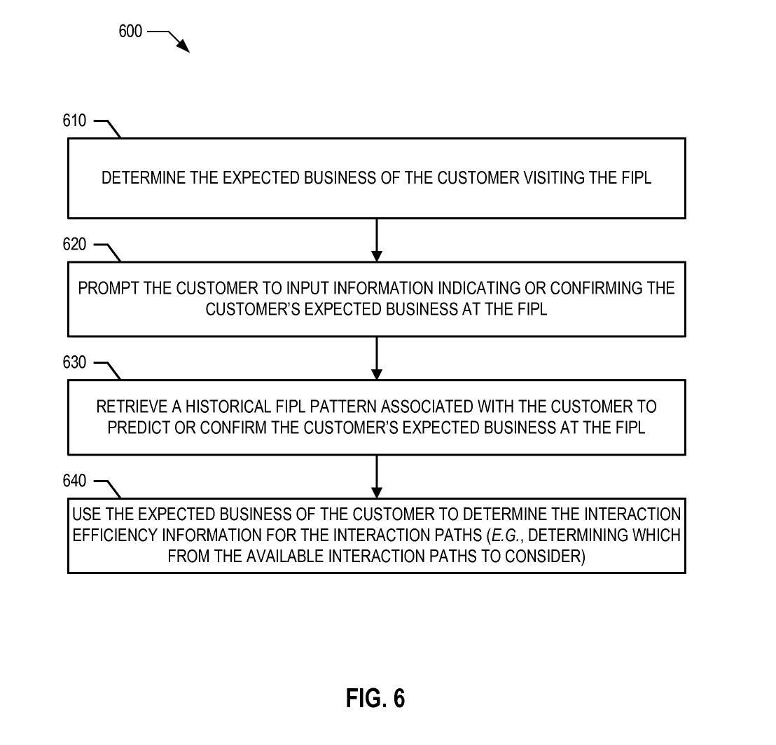

Referring now to FIG. 6, a flowchart illustrates a method 600 for determining the expected business of the customer according to embodiments of the invention. The first step, represented by block 610, is to determine the expected business of the customer visiting the FIPL. This may be done in a variety of ways, for example, by predicting the expected business of the customer as discussed in greater detail below, based on confirmation or information provided by the customer or otherwise.

The next step, represented by block 620, is to prompt the customer to input information indicating or confirming the customer's expected business at the FIPL. The next step, represented by block 630, is to retrieve a historical FIPL pattern associated with the customer to predict or confirm the customer's expected business at the FIPL. The next step, represented by block 640, is to use the expected business of the customer in determining the interaction efficiency information for the interaction paths. For example, the invention may determine which from a group of available interaction paths to consider based on which interaction paths correspond to the expected business of the customer.

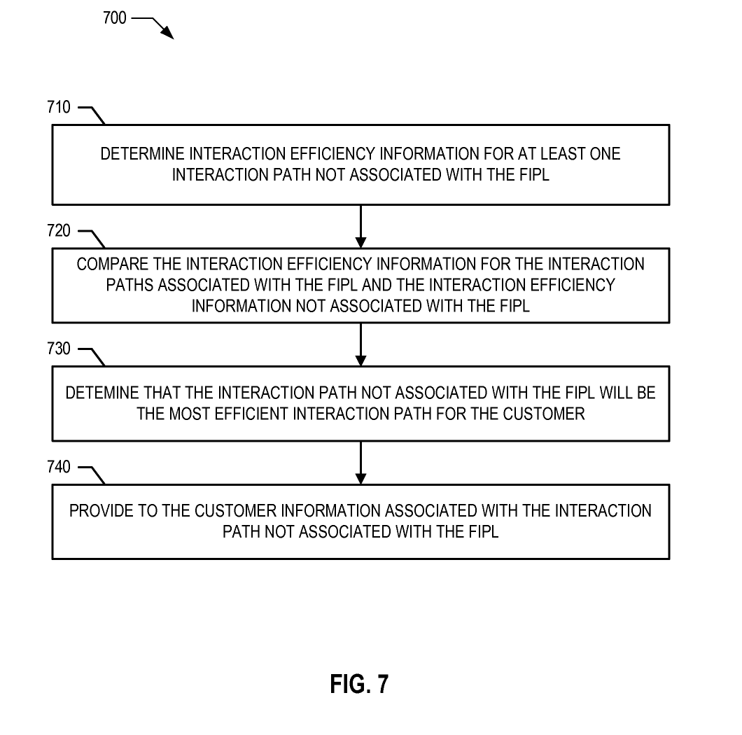

Referring now to FIG. 7, a flowchart illustrates a method 700 for determining an interaction path not associated with the FIPL. The first step, represented by block 710, is to determine interaction efficiency information for at least one interaction path not associated with the FIPL, such as one associated with another FIPL. The next step, represented by block 720, is to compare the interaction efficiency information for the interaction paths associated with the FIPL and the interaction efficiency information not associated with the FIPL. The next step, represented by block 730, is to determine that the interaction path not associated with the FIPL will be the most efficient interaction path for the customer. This may be done by comparing the amount of time the customer will have to wait for service at the current FIPL versus the amount of time the customer will have to wait for service at the other FIPL. The next step, represented by block 740, is to provide to the customer information associated with the interaction path not associated with the FIPL.

In various embodiments, the customer's expected business may be determined by prompting the customer (such as by mobile device) to input the customer's intended business at the FI. As indicated, the customer's expected business may be determined in other ways also, such as by an analysis of historical patterns of the customer. For example, the customer may deposit a check at the FI on the first day of every month. If the invention determines that the customer may be in route to the FI on the first of the month, the invention may assume the customer is planning to deposit a check. This determination may be used to determine which of the FIPL's channels or stations would be relevant to the customer's business. In this regard, the invention may filter the group of channels it considers for determining the most efficient interaction path for the customer. Further, in situations where the customer's expected business with the FI is determined based on historical data or otherwise, the customer may be prompted to confirm his or her expected activity with the FI.

In various embodiments, one or more of the considered interaction paths may be external to a specific FIPL such as at a different FIPL or a mobile channel such as mobile banking.

In various embodiments, customer characteristics may also be used to determine the most appropriate interaction path for a customer. For example, if a customer speaks a foreign language, is handicapped or otherwise, this information may be used to filter the interaction paths under consideration.

In some embodiments, if the customer is in route to the FIPL, information such as traffic density and patterns may be used in determining the most efficiency interaction path.

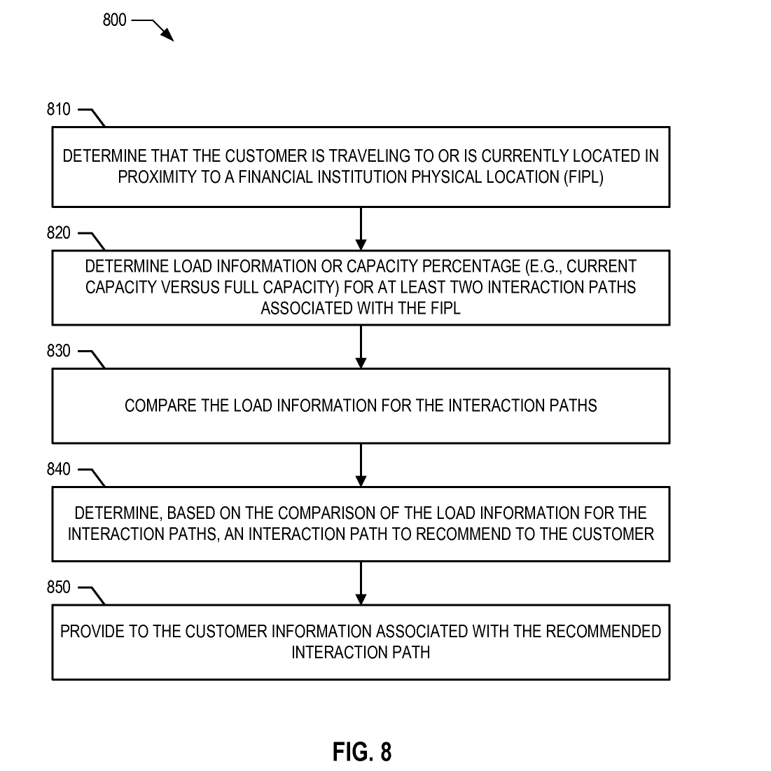

Referring now to FIG. 8, a flowchart illustrates a method 800 for balancing a load of financial transaction channels according to embodiments of the invention. The first step, represented by block 810, is to determine that the customer is travelling to or is currently located in proximity to a FIPL. The next step, represented by block 820, is to determine load information or capacity percentage. For example, the capacity percentage may be based on the current capacity of the channel versus its full capacity. The capacity percentage may be determined for two or more interaction paths associated with the FIPL. The next step, represented by block 830, is to compare the load information for the interaction paths. The next step, represented by block 840, is to determine an interaction path to recommend to the customer. In some embodiments, for example, this determination is based on the comparison of the load information for the different interaction paths. The next step, represented by block 850, is to provide to the customer information associated with the recommended interaction path.

Thus, embodiments of the invention may determine a particular FI channel is experiencing problems or overload. The invention may consider this in making a determination of a recommend interaction path for the customer. This may be based on actual lines, historical information indicating average expected wait time, subjective information regarding a particular channel and/or the like. Based on this determination, the invention may shift or recommend customer traffic to other channels in a load balancing effort.

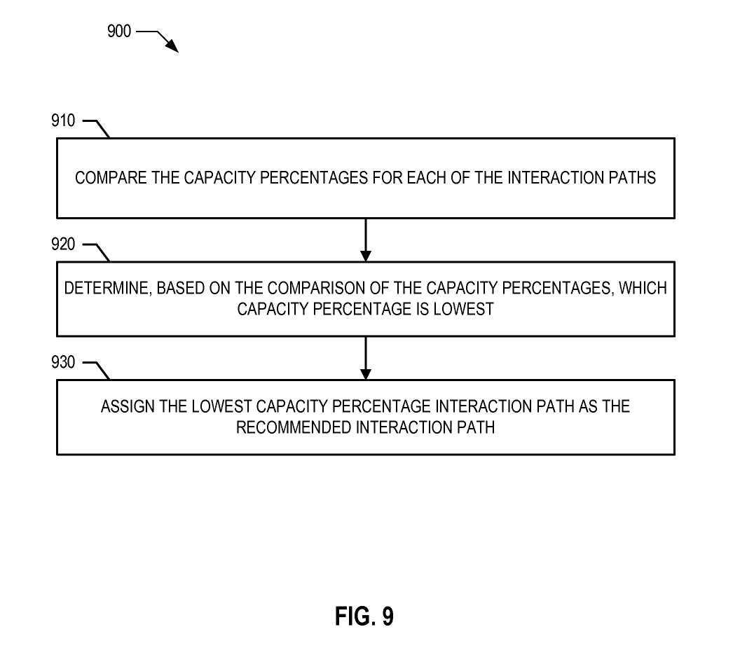

Referring now to FIG. 9, a flowchart illustrates a method 900 for determining a recommended interaction path according to embodiments of the invention. The first step, represented by block 910, is to compare the capacity percentages for each of the interaction paths. The next step, represented by block 920, is to determine which capacity percentage is the lowest capacity percentage among those considered. This may be based on the comparison of the capacity percentages of step 910. The next step, represented by block 930, is to assign the lowest capacity percentage interaction path as the recommended interaction path.

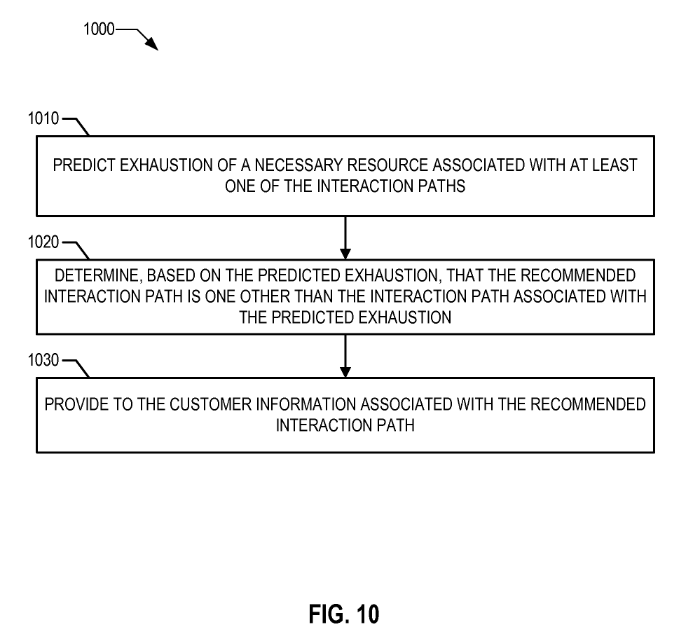

Referring now to FIG. 10, a flowchart illustrates a method 1000 for determining a recommended interaction path according to embodiments of the invention. The first step, represented by block 1010 is to predict exhaustion of a necessary resource associated with at least one of the interaction paths being considered. The next step, represented by block 1020, is to determine that the recommended interaction path is one other than the interaction path associated with the predicted exhaustion. In some embodiments, this is based on the exhaustion predicted in step 1010. The next step, represented by block 1030, is to provide to the customer information associated with the recommended interaction path.

For example, a particular ATM may be low on cash or experiencing technical difficulties. The invention may send alerts to a customer to steer the customer to another ATM. The invention may predict when the ATM will exhaust its resource (i.e., cash) and recommend only a particular additional number of customers go to the ATM based on that prediction.

As another example, an ATM or a FIPL such as a branch may be experiencing excessive customer usage. In this case, the invention may alert customers of other alternatives.

In some embodiments, the invention may provide customers incentives for choosing a different and/or less busy location or interaction path. In various embodiments, the invention may present to the customer additional information to steer the customer to an alternate channel. This other information may include visual representations of lines or other information about the current status of channels. For example, the invention may provide a countdown clock indicating a ten minute wait at one channel and a five minute wait at another channel.

In various embodiments, other customer information, such as customer preferences that may be pre-established by the customer such as through online banking, may be taken into consideration when determining the interaction path recommendation. For example, the customer may prefer a green option, such as an option that minimizes the customer's carbon footprint.

In some embodiments, if the FI determines that one or more channels are overloaded, are running low on a necessary resource or if the FI wishes to push customer traffic to another channel, then the FI may mask certain channels. For example, the user interface on the customer's mobile device may provide a graphical representation of multiple available interaction paths. In some embodiments, the FI may mask or eliminate certain interaction paths from view, effectively removing the interaction paths from the customer's consideration based on the above-discussed factors. In some embodiments, these interactions paths are not masked but they are presented and the overload or other issues are also presented to the customer for consideration.

In various embodiments, the FI presents one or more offers to the customer that are redeemable if the customer accepts the recommended interaction path.

Embodiments of the invention may provide provides special resource availability information, for example, to a customer who is in route to a financial institution physical location such as a branch location. A special resource may be a specialist at the branch location such as a financial planner, portfolio manager, personal banker, broker or the like. The invention determines the availability of the specialist at the branch location based on input from the specialist, for example, the specialist “clocking in and out” of the branch. The invention may also determine the availability of a specialist by recognizing the presence of a tag carried by the specialist, the presence of the specialist's mobile device at the branch location or based on the specialist being logged on at a workstation at the branch location. The special resource availability information may be pushed to customers and/or may be used as input in determining an appropriate interaction path for the customer. For example, if the specialist required by the customer for performing a special interaction is not available, the invention can recommend an alternate location where a similar specialist will be available to interact with the customer.

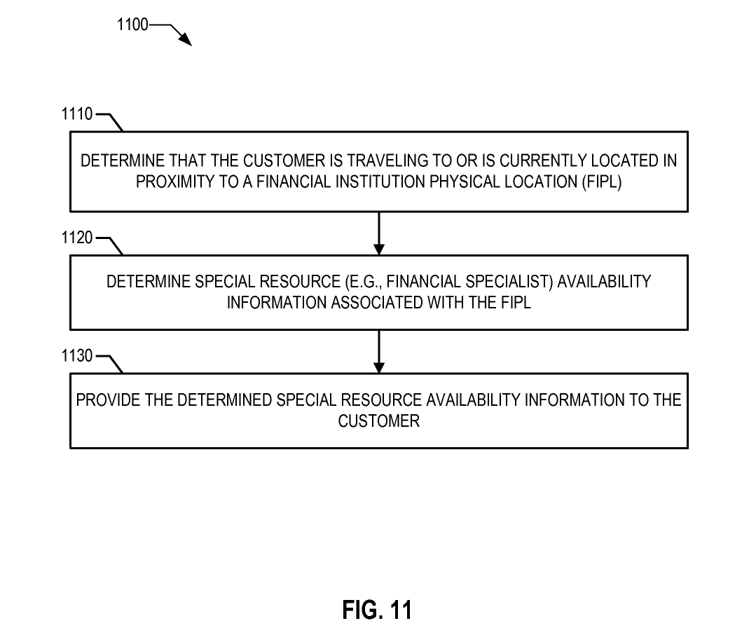

Referring now to FIG. 11, a flowchart illustrates a method 1100 for providing special resource availability information to a customer. The first step, represented by block 1110, is to determine that the customer is travelling to or is currently located in proximity to a FIPL as discussed in detail above. The next step, represented by block 1120, is to determine special resource availability information associated with the FIPL. For example, in some embodiments, the special resource is or includes a financial specialist as discussed above. The next step, represented by block 1130, is to provide the determined special resource availability information to the customer.

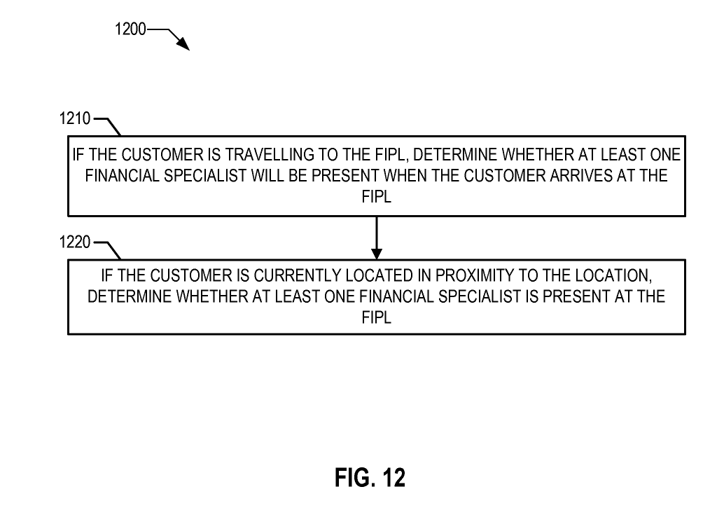

Referring now to FIG. 12, a flowchart illustrates a method 1200 for determining presence of a financial specialist at the FIPL according to embodiments of the invention. The first step, represented by block 1210, is to determine whether at least one financial specialist will be present when the customer arrives at the FIPL if the customer is travelling to the FIPL. The next step, represented by block 1220, is to determine whether at least one financial specialist is present at the FIPL if the customer is currently located in proximity to the location.

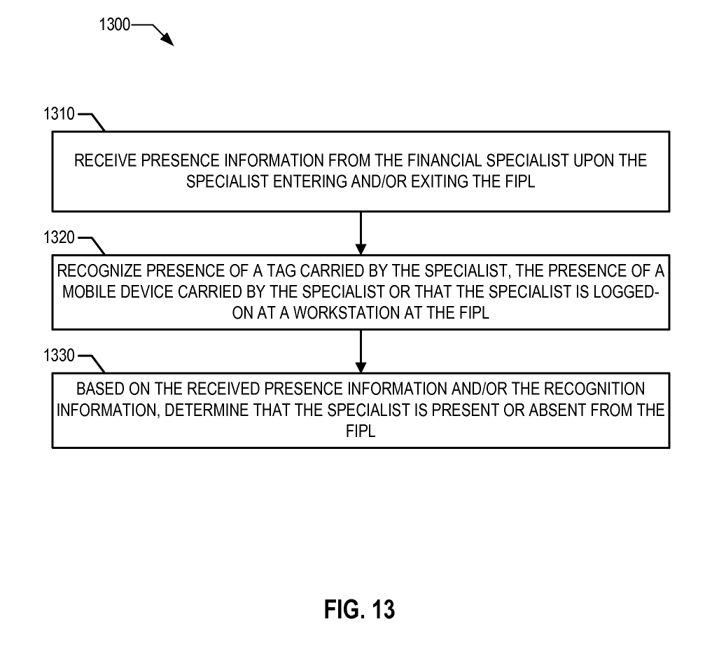

Referring now to FIG. 13, a flowchart illustrates a method 1300 for determining whether a special resource is present or absent from the FIPL according to embodiments of the invention. The first step, represented by block 1310, is to receive presence information from the financial specialist upon the specialist entering and/or exiting the FIPL. The next step, represented by block 1320, is to recognize presence of a tag carried by the specialist, the presence of a mobile device carried by the specialist or that the specialist is logged-on at a workstation at the FIPL. The next step, represented by block 1330, is to determine that the specialist is present or absent from the FIPL based on the received presence information and/or the recognition information.

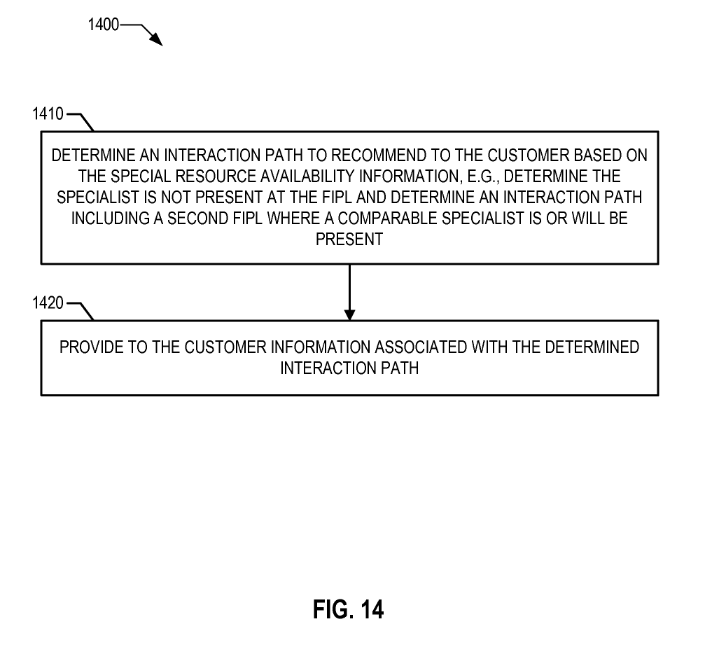

Referring now to FIG. 14, a flowchart illustrates a method 1400 for providing a recommended interaction path to a customer according to embodiments of the invention. The first step, represented by block 1410, is to determine an interaction path to recommend to the customer based on the special resource availability information. For example, in some embodiments, the specialist is determined not to be present at the FIPL and then an interaction path is determined to include a second FIPL different from the other FIPL. The second FIPL is included because it has a specialist comparable to the absent specialist of the other FIPL. The next step, represented by block 1420, is to provide to the customer information associated with the determined interaction path.

In various embodiments, the invention determines that the specialist is not available at the FIPL and a second FIPL where a comparable specialist is or will be available is determined. In this way, the invention may recommend a different interaction path for the customer so that the customer can complete his or her business with a comparable specialist. In some embodiments, a database of comparable specialists is maintained and in others, a specialist's credentials and/or title is used by the system to determine which specialists are comparable.

In various embodiments, one or more of the method steps discussed above may be combined with one or more of the method steps discussed with reference to the same and/or different figures. In various embodiments one or more of the method steps discussed above are not required and are omitted from the method. In various embodiments, one or more of the method steps discussed above may be combined with one or more of the other method steps discussed above and/or one or more additional steps not discussed herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A system for providing interaction efficiency information to a customer, the system comprising:
a memory device storing computer executable code;
a processing device to execute the computer executable code to cause the processing device to:
determine that the customer is traveling to a financial institution physical location, wherein determining comprises:
determining positioning data associated with a mobile device of the customer;
projecting a likely route of travel of the customer based at least in part on the positioning data; and
determining that the likely route of travel of the customer includes the financial institution physical location;
determine interaction efficiency information comprising one or more wait times associated with the financial institution physical location; and
provide the determined interaction efficiency information to the customer;
wherein the one or more estimated wait times are calculated at least in part by determining how an experience level associated with a specific teller of the financial institution physical location and non-normal characteristics of the specific teller of the financial institution affect an average wait time associated with the financial institution physical location.

2. The system of claim 1, wherein the interaction efficiency information comprises information related to one or more wait times at the financial institution physical location.

3. The system of claim 2, wherein the one or more wait times comprise a wait time for a drive through station outside the financial institution physical location and a wait time for a teller inside the financial institution physical location.

4. The system of claim 1, wherein the interaction efficiency information comprises one or more visual representations of one or more wait lines associated with one or more stations of the financial institution physical location.

5. The system of claim 1, wherein the interaction efficiency information comprises one or more estimated wait times associated with one or more stations of the financial institution physical location.

6. The system of claim 5, wherein the one or more estimated wait times are calculated based on a number of people in a wait line for a station and historical data associated historical average wait time data for a person to matriculate through a hypothetical station representing the station.

7. The system of claim 1, wherein the one or more estimated wait times are calculated based on a specific station of the financial institution physical location.

8. A computer program product configured for providing interaction efficiency information to a customer, the computer program product comprising a non-transitory computer readable medium having computer executable code stored thereon to cause a processing device to:
determine that the customer is traveling to a financial institution physical location, wherein determining comprises:
determining positioning data associated with a mobile device of the customer;
projecting a likely route of travel of the customer based at least in part on the positioning data; and
determining that the likely route of travel of the customer includes the financial institution physical location;
determine interaction efficiency information comprising one or more wait times associated with the financial institution physical location; and
provide the determined interaction efficiency information to the customer;
wherein the one or more estimated wait times are calculated at least in part by determining how an experience level associated with a specific teller of the financial institution physical location and non-normal characteristics of the specific teller of the financial institution affect an average wait time associated with the financial institution physical location.

9. The computer program product of claim 8, wherein the interaction efficiency information comprises information related to one or more wait times at the financial institution physical location.

10. The computer program product of claim 9, wherein the one or more wait times comprise a wait time for a drive through station outside the financial institution physical location and a wait time for a teller inside the financial institution physical location.

11. The computer program product of claim 8, wherein the interaction efficiency information comprises one or more visual representations of one or more wait lines associated with one or more stations of the financial institution physical location.

12. The computer program product of claim 8, wherein the interaction efficiency information comprises one or more estimated wait times associated with one or more stations of the financial institution physical location.

13. The computer program product of claim 12, wherein the one or more estimated wait times are calculated based on a number of people in a wait line for a station and historical data associated historical average wait time data for a person to matriculate through a hypothetical station representing the station.

14. The computer program product of claim 8, wherein the one or more estimated wait times are calculated based on a specific station of the financial institution physical location.

15. A method for providing interaction efficiency information to a customer, the method comprising:
determining, using a processing device, that the customer is traveling to a financial institution physical location, wherein the determining comprises:
determining positioning data associated with a mobile device of the customer;
projecting a likely route of travel of the customer based at least in part on the positioning data; and
determining that the likely route of travel of the customer includes the financial institution physical location;
determining, using the processing device, interaction efficiency information comprising one or more wait times associated with the financial institution physical location; and
providing, using the processing device, the determined interaction efficiency information to the customer;
wherein the one or more estimated wait times are calculated at least in part by determining how an experience level associated with a specific teller of the financial institution physical location and non-normal characteristics of the specific teller of the financial institution affect an average wait time associated with the financial institution physical location.

16. The method of claim 15, wherein the interaction efficiency information comprises information related to one or more wait times at the financial institution physical location.

17. The method of claim 16, wherein the one or more wait times comprise a wait time for a drive through station outside the financial institution physical location and a wait time for a teller inside the financial institution physical location.

18. The method of claim 15, wherein the interaction efficiency information comprises one or more visual representations of one or more wait lines associated with one or more stations of the financial institution physical location.

19. The method of claim 15, wherein the interaction efficiency information comprises one or more estimated wait times associated with one or more stations of the financial institution physical location.

20. The method of claim 19, wherein the one or more estimated wait times are calculated based on a number of people in a wait line for a station and historical data associated historical average wait time data for a person to matriculate through a hypothetical station representing the station.

21. The method of claim 15, wherein the one or more estimated wait times are calculated based on a specific station of the financial institution physical location.
